(19) United States
(12) Patent Application Publication
(10) Pub. No.: US 2012/0123041 A1
(43) Pub. Date: May 17, 2012

(54) HIGH-VISCOSITY POLYAMIDE

(75) Inventors: Damien Zaher, Casalpusterlengo (IT); Cesare Guaita, Tradate (IT)

(73) Assignee: Rhodia Operations, Aubervilliers (FR)

(21) Appl. No.: 13/377,164

(22) PCT Filed: Jun. 4, 2010
(86) PCT No.: PCT/EP2010/057821

§ 371 Date: Feb. 3, 2012

(30) Foreign Application Priority Data
Jun. 12, 2009 (FR) 0953921

(51) Int. Cl. C08L 77/06; B29C 49/04; C08K 5/101; B29C 49/02; C08G 69/26; C08G 69/14

(52) U.S. Cl. 524/504; 528/335; 528/323; 528/341; 528/342; 524/606; 524/514; 525/418; 524/315; 264/555

(57) ABSTRACT

A polyamide, a method for manufacturing the polyamide and compositions that include the polymer are described. A high-viscosity polyamide obtained by the polymerization of diacid and diamine monomers in the presence of multifunctional and, optionally, monofunctional compounds are also described. The polyamide can be used in particular for the production of compositions intended, for example, for being molded or blown.

The present invention relates to a polyamide, to a process for manufacturing it and to compositions containing it. The invention more particularly concerns a high-viscosity polyamide obtained by polymerization of diacid and diamine monomers in the presence of multifunctional and optionally monofunctional compounds. This polyamide is especially useful for the manufacture of compositions that are intended, for example, to be molded or blow molded.

Polyamide-based thermoplastic compositions are raw materials that can be converted in various ways, especially by molding or blow molding. The polyamides generally used are aliphatic, aromatic or semiaromatic, linear polyamides.

The processes for shaping these compositions, such as, for example, extrusion blow molding, require compositions having a high viscosity in the melt state so that the part extruded before the blow molding does not deform, or deforms only slightly under the effect of its own weight. However, the mechanical, elastic and impact strength properties of the parts must not be affected, or affected only slightly. Certain solutions have been proposed, such as the use of high-viscosity linear polyamides obtained by post-condensation in a solid medium, or by addition of chain extenders. However, these solutions are often difficult to implement or impair certain properties of the parts obtained. Furthermore, it is preferable to use conventional industrial polymerization processes for manufacturing high-viscosity polyamides, without drastically modifying them.

The Applicant has developed a polyamide modified with multifunctional and optionally difunctional and/or monofunctional compounds that has an increased viscosity and mechanical properties that are equivalent or superior to those of conventional linear polyamides. These modified polyamides are obtained simply via quite conventional polymerization processes without necessarily carrying out subsequent post-condensation steps.

Such a polyamide is obtained by polymerization of dicarboxylic acid and diamine monomers, of a multifunctional compound containing at least 3 acid or amine functions capable of forming an amide bond with the functions of said dicarboxylic acid and diamine monomers, and optionally of difunctional and/or monofunctional compounds containing acid or amine functions, which are capable of forming an amide function with the functions of said dicarboxylic acid and diamine monomers. The polymerization process is conventional and corresponds to that usually used for the polymerization of polyamide based on diacid and diamine monomers, such as polyamide PA-6,6.

A first subject of the present invention is thus a branched polyamide obtained by polymerization in the presence of at least:
dicarboxylic acid monomers (a) of the type AA and diamine monomers of the type BB, or salts thereof;
a multifunctional compound (b) comprising at least 3 functions A or B;
   the functions A and B being functions that are capable of reacting together to form an amide bond;
   the polyamide obtained having a difference in absolute value ΔGT between its end groups of between 30 and 150; and
   the polyamide having a VN of between 150 and 300 ml/g, preferably from 160 to 250 ml/g, according to standard ISO 307.

The modified polyamide according to the invention has a high viscosity and excellent mechanical properties, while avoiding gelation, using a conventional polymerization process. This polyamide furthermore has an excellent capacity for compatibilization in the presence of impact modifiers that have functions capable of reacting with the functions of the polyamide.

It is clearly understood that the difference between the end groups ΔGT should be taken as its absolute value, i.e. always positive.

The functions A and B are functions that are capable of reacting together to form an amide bond. Function A may be a carboxylic acid function or a salt thereof or alternatively a precursor function of function A capable of generating a function A in the polymerization medium. Mention may be made especially of nitrile, primary amide, anhydride and ester functions. Function B may be a primary or secondary amine function or a salt thereof or alternatively a precursor function of function B that is capable of generating a function B in the polymerization medium. Mention may be made especially of isocyanate and carbamate functions.

The amounts of amine and/or acid end groups are determined by potentiometric titrations after dissolving the polyamide. One method is, for example, described in “Encyclopedia of Industrial Chemical Analysis”, volume 17, page 293, 1973.

It is thus seen that, according to the invention, the modified polyamide obtained has a ΔGT value between 30 and 150, preferably between 35 and 90. To obtain such a ΔGT, a person skilled in the art is entirely capable of adding to the polymerization of the compounds, especially of dicarboxylic acid or diamine monomers, and/or of monocarboxylic acid or monoamine monomers, if necessary. Needless to say, depending on the polymerization processes used and the loss of volatile monomers resulting therefrom, a person skilled in the art, knowing his installation, will be capable of making the necessary corrections as regards the proportions of monomers and compounds (a) and (b) introduced so as to obtain the desired ΔGT. The difference between the end groups ΔGT may especially be calculated by adding the ΔGT induced by the addition of compounds (a) and (b), and the ΔGT calculated or measured by the loss of volatile compounds in the polymerization process.

It is the same for obtaining the desired VN of between 130 and 300. It is entirely possible to carry out various VN measurements on various formulations to obtain the polyamide having the desired VN.

It is entirely possible to add, for example in polymerization, an equimolar amount of dicarboxylic acid and diamine, and a certain proportion of dicarboxylic acid or diamine, of identical or different nature.

The term “number of moles of constituent monomers of the polyamide” means the total number of moles of monomer units and of units corresponding to the other constituents of said polyamide, i.e. the number of moles of dicarboxylic acid and diamine monomer (a) units, the number of moles of compounds (b) and optionally the number of moles of other compounds or monomers. The molar percentage of a compound corresponds to the number of moles of this compound relative to the number of moles of constituent monomers of the polyamide.

Preferably, the polyamide according to the invention is obtained by polymerization of dicarboxylic acid and diamine monomers, or salts thereof, and a single type of multifunctional compound (b).

The dicarboxylic acid and diamine monomers (a) are especially those conventionally used for the manufacture:
of aliphatic polyamides, of the type PA-6,6, PA-6,10, PA-6,12, PA-12,12 and PA-4,6,
of semiaromatic polyamides, such as poly(m-xylylenediamine adipate) (MXD6), polyterephthalamides, such as polyamides PA-6,T, PA-9,T and PA-6,6/6,T, and polyisophthalamides, such as polyamides PA-6,I and PA-6,6/6,I,
of polyaramids,
or of copolymers thereof.

These dicarboxylic acid and/or diamine monomers may be aliphatic, especially with a linear, branched or cyclic chain, or aromatic.

Dicarboxylic acid monomers that may especially be mentioned include aliphatic or aromatic dicarboxylic acids containing from 4 to 12 carbon atoms, such as adipic acid, terephthalic acid, isophthalic acid, pimelic acid, suberic acid, decanedioic acid and dodecanedioic acid.

Diamine monomers that may especially be mentioned include aliphatic, optionally cycloaliphatic, or aromatic diamines containing from 4 to 12 carbon atoms, such as hexamethylenediamine, butanediamine, m-xylylenediamine, isophoronediamine, 3,3′,5-trimethyl-hexamethylenediamine and methylpentamethylenediamine.

The monomers may optionally be combined in the form of salts of the dicarboxylic acid and diamine monomers.

It is especially preferred according to the present invention to use the constituent monomers of polyamide PA-6,6, which are adipic acid and hexamethylenediamine, or the salt thereof, such as hexamethylenediammonium adipate, also known as Nylon salt or N salt.

The modified polyamide according to the invention may comprise one or more dicarboxylic acids and one or more diamines, of various types.

The multifunctional compound (b) according to the invention comprises at least 3 acid or amine functions. This compound advantageously has 3 acid or amine functions. This compound preferably has 3 amine functions.

This multifunctional compound is generally an aliphatic, cycloaliphatic and/or aromatic hydrocarbon-based compound comprising from 1 to 100 carbon atoms and possibly comprising one or more heteroatoms. The heteroatoms may be O, S, N or P.

The multifunctional compound may especially comprise a cyclohexyl, a cyclohexanoyl, a benzyl, a naphthyl, an anthracenyl, a biphenyl, a triphenyl, a pyridine, a bipyridine, a pyrrole, an indole, a furan, a thiophene, a purine, a quinoline, a phenanthrene, a porphyrin, a phthalocyanine, a naphthalocyanine, a 1,3,5-triazine, a 1,4-diazine, a 2,3,5,6-tetraethylpiperazine, a piperazine and/or a tetrathiafulvalene.

As examples of multifunctional compounds bearing amine functions, mention may be made especially of nitrilotrialkylamines, in particular nitrilotriethyl-amine, dialkylenetriamines, in particular diethylene-triamine, bishexamethylenetriamine, 4-aminomethyl-1,8-octanediamine, melamine, and polyalkylenetriamines, for instance the Jeffamine T® products from the company Huntsman, especially Jeffamine T403® (polyoxypropylene-triamine).

As multifunctional compounds (b) bearing precursor functions of the function B of amine type, mention may be made especially of isocyanates or carbamates of the polyamine compounds mentioned previously.

As multifunctional compounds (b) bearing carboxylic acid functions, mention may be made especially of 2,2,6,6-tetrakis(β-carboxyethyl)cyclohexanone, diamino-propane-N,N,N′,N′-tetraacetic acid, 3,5,3′,5′-biphenyl-tetracarboxylic acid, acids derived from phthalocyanine and naphthalocyanine, 3,5,3′,5′-biphenyltetracarboxylic acid, 1,3,5,7-naphthalenetetracarboxylic acid, 2,4,6-pyridinetricarboxylic acid, 3,5,3′,5′-bipyridyltetra-carboxylic acid, 3,5,3′,5′-benzophenonetetracarboxylic acid, 1,3,6,8-acridinetetracarboxylic acid, trimesic acid, 1,2,4,5-benzenetetracarboxylic acid and 2,4,6-triaminocaproic acid-1,3,5-triazine (TACT).

As examples of multifunctional compounds (b) bearing precursor functions of the function A of carboxylic acid type, mention may be made especially of nitriles, primary amides, anhydrides or esters of the polyacid compounds mentioned previously.

Examples of multifunctional compounds that may be suitable are especially cited in U.S. Pat. No. 5,346,984, U.S. Pat. No. 5,959,069, WO 96/35739 and EP 672 703.

Preferably, a multifunctional compound (b) comprising 3 functions B is used.

The branched polyamide of the invention may be obtained by polymerization in the presence of 0.05 mol % to 0.4 mol % of a monofunctional compound (b) comprising at least 3 functions A or B, relative to the number of moles of constituent monomers of the polyamide.

The polyamide according to the invention may also be formed using monofunctional compounds of monoamine or monocarboxylic acid type. The monofunctional compound is preferably chosen from the group comprising: n-hexadecylamine, n-octadecylamine and n-dodecylamine, acetic acid, lauric acid, benzylamine, benzoic acid, propionic acid and 4-amino-2,2,6,6-tetramethyl-piperidine.

Amino acids or lactams thereof, for instance caprolactam, may also be added to the dicarboxylic acid and diamine monomers. From 1 mol % to 25 mol % and preferably from 2 mol % to 15 mol % of amino acids or lactams, relative to the number of moles of constituent monomers of the polyamide, may especially be added to the reaction medium.

The polymerization of the process of the invention is especially performed according to standard operating conditions for the polymerization of dicarboxylic acids and diamines, when this is performed in the absence of multifunctional compounds.

Such a polymerization process may briefly comprise:
heating, with stirring and under pressure, of the mixture of monomers and multifunctional compounds,
maintenance of the mixture under pressure and temperature for a given time, with removal of water vapor using a suitable device, followed by decompression and maintenance for a given time at a temperature above the melting point of the mixture, especially under the autogenous pressure of the water vapor, under nitrogen or under vacuum, in order thus to continue the polymerization by removal of the water formed.

It is entirely possible to carry out the polymerization until thermodynamic equilibrium of the polyamide is obtained.

The multifunctional and optionally monofunctional compounds are preferentially added at the start of the polymerization. In this case, polymerization of a mixture of dicarboxylic acid and diamine monomers and of the multifunctional and monofunctional compounds is performed.

It is entirely possible to add at the start, during or at the end of polymerization common additives, for instance catalysts, especially such as phosphorus-containing catalysts, antifoams, and light or heat stabilizers.

At the end of polymerization, the polymer may be cooled advantageously with water, and extruded, and then chopped to produce granules.

The polymerization process according to the invention may entirely be performed in continuous or batch mode.

It is also possible to obtain the branched polyamides according to the present invention as described previously by firstly manufacturing prepolymers and then carrying out a liquid or solid post-condensation step.

According to the invention, the modified polyamide preferably has a solution viscosity number of between 150 and 300, according to standard ISO 307 (with 0.5% polymer in solution in 90% formic acid, at a temperature of 25° C.), especially between 160 and 250.

A subject of the present invention is also a composition comprising at least the polyamide as defined previously, and fillers and/or additives.

Preferably, the polyamide of the invention is used as matrix in this composition, especially for obtaining blow-molded or molded articles. Such a composition may comprise from 30% to 95% by weight of polyamide according to the invention.

To improve the mechanical properties of this composition, it may be advantageous to add thereto at least one reinforcing and/or bulking filler preferably chosen from the group comprising fibrous fillers such as glass fibers, mineral fillers such as clays, kaolin, or reinforcing nanoparticles or nanoparticles made of thermosetting material, and fillers in powder form such as talc. The level of incorporation of reinforcing and/or bulking filler is in accordance with the standards in the field of composite materials. It may be, for example, a filler content of from 1% to 80%, preferably from 10% to 70% and especially between 30% and 60%.

Besides the modified polyamide of the invention, the composition may comprise one or more other polymers, preferably polyamides or copolyamides.

The composition according to the invention may also comprise additives commonly used for the manufacture of polyamide compositions intended to be molded. Thus, mention may be made of lubricants, flame retardants, plasticizers, nucleating agents, catalysts, resilience improvers, for instance optionally grafted elastomers, light and/or heat stabilizers, antioxidants, antistatic agents, colorants, matting agents, molding additives or other conventional additives.

These fillers and additives may be added to the modified polyamide via the usual means suitable for each filler or additive, for instance during the polymerization or by cold blending or melt blending.

The composition according to the invention comprising the polyamide as defined previously may also comprise at least one impact modifier, i.e. a compound capable of modifying the impact strength of a polyamide composition. These impact modifier compounds preferably comprise functional groups that are reactive with the polyamide.

According to the invention the expression “functional groups that are reactive with the polyamide” is understood to mean groups capable of reacting or interacting chemically with the acid or amine functions of the polyamide, especially via covalent bonding, ionic interaction, hydrogen bonding or van der Waals bonding. Such reactive groups make it possible to ensure a good dispersion of the impact modifiers in the polyamide matrix. Generally, a good dispersion is obtained with particles of impact modifiers having a mean size between 0.1 and 1 μm in the matrix.

Use is preferably made of impact modifiers comprising functional groups that are reactive with the polyamide as a function of the acid or amine nature of the ΔGT of the polyamide. Thus, for example, if the ΔGT is acid, use will preferably be made of reactive functional groups capable of reacting or interacting chemically with the acid functions of the polyamide, especially via covalent bonding, ionic interaction, hydrogen bonding or van der Waals bonding. Thus, for example, if the ΔGT is amine, use will preferably be made of reactive functional groups capable of reacting or interacting chemically with the amine functions of the polyamide, especially via covalent bonding, ionic interaction, hydrogen bonding or van der Waals bonding.

Use is preferably made of impact modifiers having functional groups that are reactive with the polyamide having a ΔGT of amine nature.

The impact modifiers may very well comprise, by themselves, functional groups that are reactive with the polyamide, for example as ethylene-acrylic acid (EAA) copolymers.

It is also possible to add thereto functional groups that are reactive with the polyamide, generally by grafting or copolymerization, for example for ethylene-propylene-diene (EPDM), grafted by maleic anhydride.

It is possible to use, according to the invention, impact modifiers that are oligomeric or polymeric compounds comprising at least one of the following monomers, or a mixture thereof: ethylene, propylene, butene, isoprene, diene, acrylate, butadiene, styrene, octene, acrylonitrile, acrylic acid, methacrylic acid, vinyl acetate, vinyl esters such as acrylic and methacrylic esters and glycidyl methacrylate. These compounds according to the invention may also comprise, in addition, monomers other than those mentioned previously.

The base of the impact modifier compound, optionally referred to as elastomeric base, may be chosen from the group comprising: polyethylenes, polypropylenes, polybutenes, polyisoprenes, ethylene-propylene rubbers (EPRs), ethylene-propylene-diene rubbers (EPDMs), ethylene-butene rubbers, ethylene-acrylate rubbers, butadiene-styrene rubbers, butadiene-acrylate rubbers, ethylene-octene rubbers, butadiene-acrylonitrile rubbers, ethylene-acrylic acid (EAA) copolymers, ethylene-vinyl acetate (EVA) copolymers, ethylene-acrylic ester (EEA) copolymers, acrylonitrile-butadiene-styrene (ABS) copolymers, styrene-ethylene-butadiene-styrene (SEBS) block copolymers, styrene-butadiene-styrene (SBS) copolymers, core-shell elastomers of methacrylate-butadiene-styrene (MBS) type, or mixtures of at least two elastomers listed above.

In addition to the groups listed above, these impact modifiers may also comprise, generally grafted or copolymerized, functional groups that are reactive with the polyamide, such as the following functional groups especially: acids, such as carboxylic acids, salified acids, esters in particular, acrylates and methacrylates, ionomers, glycidyl groups especially epoxy groups, glycidyl esters, anhydrides especially maleic anhydrides, oxazolines, maleimides, or mixtures thereof.

Such functional groups on the elastomers are for example obtained by the use of a comonomer during the preparation of the elastomer.

As impact modifiers comprising functional groups that are reactive with the polyamide, mention may especially be made of terpolymers of ethylene, acrylic ester and glycidyl methacrylate, copolymers of ethylene and butyl ester acrylate, copolymers of ethylene, n-butyl acrylate and glycidyl methacrylate, copolymers of ethylene and maleic anhydride, styrene-maleimide copolymers grafted with maleic anhydride, styrene-ethylene-butylene-styrene copolymers modified with maleic anhydride, maleic anhydride grafted styrene-acrylonitrile copolymer, maleic anhydride grafted acrylonitrile-butadiene-styrene copolymers, and the hydrogenated versions thereof.

The proportion, by weight, of impact modifiers in the total composition is especially between 0.1% and 50%, preferably between 0.1% and 20%, and especially between 0.1% and 10%, relative to the total weight of the composition.

The polyamide according to the invention may also be used as matrix in a composition comprising a high proportion of additives of masterbatch type intended to be mixed with another thermoplastic composition.

The polyamide according to the invention may also be used, as additive, or as a mixture, especially for imparting certain properties, especially rheological properties, to compositions comprising as matrix a thermoplastic polymer, especially a (co)polyamide. The polyamide according to the invention is then generally melt blended with thermoplastic polymers. It is especially possible to use a proportion of between 10% and 90% by weight of (co)polyamide, such as a linear (co)polyamide, preferably from 30% to 80% by weight, relative to the total proportion of (co)polyamide and polyamide according to the invention.

The polyamides or compositions according to the invention may be used as raw material in the field of engineering plastics. According to a common embodiment, the modified polyamide is extruded in the form of rods, for example in a twin-screw extrusion device, and these rods are then chopped into granules. The articles are then made by melting the granules produced above and feeding the molten composition into processing devices especially used for producing engineering plastics, such as suitable molding devices, injection molding devices, extrusion devices, especially sheet or film extrusion devices, or extrusion blow molding devices. The fields of interest are particularly the automotive, electrical and electronic fields.

The present invention also relates to an extrusion blow molding process using a polyamide composition comprising in particular at least one branched polyamide as described previously and optionally at least one impact modifier preferably comprising functional groups that are reactive with the polyamide. The invention also relates to the use of a branched polyamide as described previously for the manufacture of articles by extrusion blow molding.

Specific terms are used in the description so as to facilitate the understanding of the principle of the invention. However, it should be understood that no limitation of the scope of the invention is envisioned by the use of these specific terms. The term “and/or” includes the meanings “and”, “or” and also any other possible combination of the elements connected to this term.

Other details or advantages of the invention will emerge more clearly in the light of the examples below, which are given purely as a guide.

### EXPERIMENTAL SECTION

### Example 1

### Manufacture of Polymers

The polymerization is performed in a heated autoclave comprising stirring means and means for evacuating volatile by-products.

27 kg of N salt (equimolar amount of adipic acid and of hexamethylenediamine), optionally variable amounts of bishexamethylenetriamine (BHT), optionally 45 g of isophorone diamine (IPD) (0.13 mol %) and 100 g of antifoam are added and mixed with 13 kg of demineralized water, the whole mixture is then introduced into the autoclave at a temperature of 200° C.

The stirred mixture is brought to a temperature of 275° C. and to a pressure of 13 bar. Next, the pressure and the temperature are kept constant for one hour. During this step, water is evaporated off. The pressure is then reduced gradually over a period of 1 h 30 min to 1 bar absolute and 275° C. Finally, the fission phase is carried out at a pressure of 0.75 bar absolute for 1 h.

The molten polymer is then extruded in the form of rods, and then rapidly cooled with water and chopped into granules.

For certain polymers, isophorone diamine (IPD) is added to compensate for the losses of HMD during the polymerization cycle.

The polymers are given in detail in table 1:

TABLE 1

| | | | | BHT | | | | |
|---|---|---|---|---|---|---|---|---|
| | | | Catalyst | Mol | | | | |
| | Polymer | IPD | (ppm/type) | (%) | VN | GTA | GTC | ΔGT |
| C1 | PA-6, 6* | — | 25/type 1 | — | 187 | 31 | 67 | 36 |
| C2 | PA-6, 6 + | — | 27/type 2 | — | 147 | 83 | 35 | 48 |
| | HMD* | | | | | | | |
| C3 | PA-6, 6 | YES | — | — | 164 | 55 | 55 | 0 |
| 4 | PA-6, 6 | YES | — | 0.1 | 175 | 73 | 38 | 35 |
| 5 | PA-6, 6 | YES | — | 0.2 | 183 | 88 | 37 | 51 |
| 6 | PA-6, 6 | YES | — | 0.2 | 161 | 94 | 50 | 44 |
| 7 | PA-6, 6 | YES | — | 0.25 | 199 | 99 | 33 | 66 |
| C8 | PA-6, 6/ | — | 31/type 1 | — | 161 | 54 | 63 | 9 |
| | 6 90/10 | | | | | | | |
| 9 | PA-6, 6/ | YES | — | 0.2 | 192 | 84 | 34 | 50 |
| | 6 90/10 | | | | | | | |

(1)Viscosity number expressed in ml/g and measured using a 0.5% solution of polymer dissolved in 90% formic acid, according to standard ISO 307
*advanced polymerization cycle (polymerization cycle that is longer or under vacuum/presence of a large amount of catalyst) in order to achieve a high viscosity
Catalysts: type 1: NaH₂PO₂•H₂O/type 2: H₃PO₄
GTA, GTC and ΔGT are expressed in meq/kg.

It is thus observed that it is not possible to achieve high viscosities in solution or in the melt state without addition of catalysts and/or a more advanced polymerization cycle (C1). Indeed, for an equilibrated polymer in a normal polymerization cycle (C3), where an optimum rise in viscosity should be observed, a viscosity of only 164 ml/g is obtained. It is also observed that it is even more difficult to obtain high viscosity with a GT difference of around 40-50 meq/kg (C2). A contrario, it is entirely possible to obtain polyamides having the desired characteristics by using multifunctional compounds according to the invention, with standard polymerization cycles.

### Example 2

### Manufacture of Formulations

Various polyamide formulations are manufactured by melt blending, in a Werner and Pfleiderer ZSK 40 twin-screw (L/D=36) extruder with degassing, of the polymers described above with 25% by weight of Exxelor 1801 (maleic anhydride grafted ethylene-propylene copolymer) and 2% by weight of stabilizer. The extrusion parameters are as follows: extrusion temperature with an increasing profile 250-270° C.; rotational speed of the screw: 250 rpm; throughput of the composition 40 kg/h; the motor torque and the absorbed motor power vary depending on the polyamides.

### Example 3

### Measurement of the Properties

Various mechanical properties were measured on the formulations from example 2, and the results are given in table 2.

TABLE 2

| Formulations | F4 | F5 | F6 |
|---|---|---|---|
| Polymer | 5 | 6 | 7 |
| Unnotched Charpy impact | 98.7 | 101.5 | 100.1 |
| (kJ/m²) (2) | | | |
| Tensile strength | 41 | 42 | 43 |
| (N/mm²) (3) | | | |
| Elongation | 94 | 92 | 87 |
| (%) (3) | | | |
| Tensile modulus | 1500 | 1640 | 1670 |
| (N/mm²) (3) | | | |

(2) Notched Charpy impact is measured according to standard ISO 179-1/1 eA at a temperature of 23° C., the tensile strength.
(3) The elongation and the tensile modulus are measured according to standard ISO 527 at a temperature of 23° C.

Moreover, tests were carried out on the behavior of the parison of these formulations. This measurement is obtained by introducing the formulated polymer into a single-screw blow molding machine at a temperature profile of 250-275° C. and at a fixed screw speed of 40 rpm; and by recording, using photocells, the time needed for the parison of molten polymer to travel a distance of 30, 50 and 75 cm. The measurement is repeated at least 5 times in order to verify the low standard deviation. Thus, the longer the travel time, the more the polymer has an advantageous morphological behavior for the manufacture of articles by extrusion blow molding.

The results are given in table 3.

TABLE 3

| | | Distance | Time |
|---|---|---|---|
| Formulation | Polymers | (cm) | (s) |
| FC1 | C1 | 0 | 0 |
| | | 30 | 19.7 |
| | | 50 | 28.64 |
| | | 75 | 36.96 |
| FC2 | C2 | 0 | 0 |
| | | 30 | 20.34 |
| | | 50 | 28.02 |
| | | 75 | 34.46 |
| FC3 | C3 | 0 | 0 |
| | | 30 | 22.02 |
| | | 50 | 30.18 |
| | | 75 | 37.2 |
| F4 | 5 | 0 | 0 |
| | | 30 | 27.96 |
| | | 50 | 38.58 |
| | | 75 | 50.7 |
| F5 | 6 | 0 | 0 |
| | | 30 | 26.9 |
| | | 50 | 38.08 |
| | | 75 | 48.26 |
| F6 | 7 | 0 | 0 |
| | | 30 | 27.52 |
| | | 50 | 39.34 |
| | | 75 | 50.52 |

It is thus observed that the formulations that contain polymers according to the invention have a parison that has a longer travel time for the same distance, compared to conventional polymers from the prior art. The polymers according to the invention are thus much more suitable for extrusion blow molding.

### Example 4

### Manufacture of Formulations

Various polyamide formulations are manufactured by melt blending, in a Werner and Pfleiderer ZSK 40 twin-screw (L/D=36) extruder with degassing, of the polymers described above with 7.5% or 15% by weight of Exxelor 1801, 15% by weight of glass fibers and 2% by weight of stabilizer. The extrusion parameters are as follows: extrusion temperature with an increasing profile 250-280° C.; rotational speed of the screw: 250 rpm; throughput of the composition 40 kg/h; the motor torque and the absorbed motor power vary depending on the polyamides.

### Example 5

### Measurement of the Properties

Various mechanical properties were measured on the formulations from example 4, and the results are given in table 4.

TABLE 4

| Formulation | FC7 | FC8 | F9 | F10 | F11 | F12 | FC13 | F14 |
|---|---|---|---|---|---|---|---|---|
| Polymer | C3 | C3 | 5 | 5 | 6 | 7 | C8 | 9 |
| Elastomers (%) | 15 | 7.5 | 15 | 7.5 | 15 | 15 | 15 | 15 |
| Unnotched Charpy | 67.5 | 66.8 | 76.8 | 71.4 | 75.7 | 77.4 | 66.3 | 80.3 |
| impact (kJ/m²) (2) | | | | | | | | |
| Tensile strength | 87 | 108 | 87 | 106 | 88 | 88 | 83 | 85 |
| (N/mm²) (3) | | | | | | | | |
| Elongation (%) (3) | 5.5 | 4.5 | 6.6 | 4.8 | 6.4 | 6.2 | 4.8 | 7.9 |
| Tensile modulus | 4380 | 5430 | 4680 | 5450 | 4500 | 4780 | 4170 | 4390 |
| (N/mm²) (3) | | | | | | | | |
| Melt viscosity | 858 | 597 | 1043 | 859 | 940 | 1311 | 754 | 903 |
| (Pa · s) (4) | | | | | | | | |

(4) Melt viscosity measured according to standard ISO 11443 at a temperature of 280° C. with a shear of 230 s⁻¹.

It is thus observed that a branched polymer (5) in a formulation (F10) containing less elastomer has a melt viscosity higher than a conventional composition (FC13) comprising a linear polymer (C8).

1. A branched polyamide, wherein the polyamide is obtained by polymerization in the presence of at least:
dicarboxylic acid monomers (a) of the type AA and diamine monomers of the type BB, or salts thereof;
a multifunctional compound (b) comprising at least 3 functions A or B;
the functions A and B being functions that react together to form an amide bond;
the polyamide obtained having a difference in absolute value ΔGT between its end groups of between 30 and 150; and
the polyamide having a VN of between 150 ml/g and 300 ml/g according to standard ISO 307.

2. The polyamide as claimed in claim 1, wherein the dicarboxylic acid monomer is an aliphatic or aromatic compound containing from 4 to 12 carbon atoms.

3. The polyamide as claimed in claim 1, wherein the diamine monomer is an aliphatic, optionally cycloaliphatic, or aromatic compound containing from 4 to 12 carbon atoms.

4. The polyamide as claimed in claim 1, wherein the polyamide monomers used are adipic acid, hexamethylenediamine or hexamethylenediammonium adipate.

5. The polyamide as claimed in claim 1, wherein the polyamide is obtained by also adding an amino acid or a lactam.

6. The polyamide as claimed in claim 1, wherein the multifunctional compound (b) is an aliphatic, cycloaliphatic and/or aromatic hydrocarbon-based compound comprising from 1 to 100 carbon atoms and optionally comprising one or more heteroatoms.

7. The polyamide as claimed in claim 1, wherein the multifunctional compound (b) is selected from the group consisting of: 2,2,6,6-tetrakis(β-carboxyethyl)cyclohexanone, diaminopropane-N,N,N′,N′-tetraacetic acid, 3,5,3′,5′-biphenyltetracarboxylic acid, acids derived from phthalocyanine and naphthalocyanine, 3,5,3′,5′-biphenyltetracarboxylic acid, 1,3,5,7-naphthalenetetracarboxylic acid, 2,4,6-pyridinetricarboxylic acid, 3,5,3′,5′-bipyridyltetracarboxylic acid, 3,5,3′,5′-benzophenonetetracarboxylic acid, 1,3,6,8-acridinetetracarboxylic acid, trimesic acid, 1,2,4,5-benzenetetracarboxylic acid and 2,4,6-triaminocaproic acid-1,3,5-triazine (TACT).

8. The polyamide as claimed in claim 1, wherein the multifunctional compound (b) is selected from the group consisting of: a nitrilotrialkylamine, a dialkylenetriamine, a trialkylenetetramine and a tetraalkylenepentamine.

9. The polyamide as claimed in claim 1, wherein the multifunctional compound (b) comprises 3 acid or amine functions.

10. The polyamide as claimed in claim 1, wherein the multifunctional compound (b) comprises 3 amine functions.

11. The polyamide as claimed in claim 1, wherein the polyamide is obtained by polymerization in the presence of 0.05 mol % to 0.4 mol % of a multifunctional compound (b) comprising at least 3 functions A or B, relative to the number of moles of constituent monomers of the polyamide.

12. The polyamide as claimed claim 1, wherein the polyamide has a solution viscosity number of between 160 and 250, according to standard ISO 307.

13. A polymerization process for the manufacture of a polyamide as claimed in claim 1, the process comprises polymerizing a mixture comprising at least the dicarboxylic acid and diamine monomers, or salts thereof, and the multifunctional compound (b).

14. A polyamide composition comprising at least one polyamide as described in claim 1, and fillers and/or additives.

15. The polyamide composition as claimed in claim 14, the polyamide further comprising at least one impact modifier, optionally comprising functional groups that react with the polyamide.

16. The polyamide composition as claimed in claim 14, the polyamide further comprising particles of impact modifiers having a mean size between 0.1 μm and 1 μm in the matrix.

17. The polyamide composition as claimed in claim 14, the polyamide further comprising impact modifiers having functional groups that reacts with the polyamide having a ΔGT of amine nature.

18. The polyamide composition as claimed in claim 14, the polyamide further comprising an impact modifier that is an oligomeric compound or a polymeric compounds wherein the impact modifier comprises at least one monomer selected from the group consisting of: ethylene, propylene, butene, isoprene, diene, acrylate, butadiene, styrene, octene, acrylonitrile, acrylic acid, methacrylic acid, vinyl acetate, a vinyl ester, glycidyl methacrylate and mixtures thereof.

19. The polyamide composition as claimed in claim 14, wherein the base of the impact modifier compound is selected from the group consisting of: a polyethylene, a polypropylene, a polybutene, a polyisoprene, an ethylene-propylene rubber (EPR), an ethylene-propylene-diene rubber (EPDM), an ethylene-butene rubber, an ethylene-acrylate rubber, a butadiene-styrene rubber, a butadiene-acrylate rubber, an ethylene-octene rubber, a butadiene-acrylonitrile rubber, an ethylene-acrylic acid (EAA) copolymer, an ethylene-vinyl acetate (EVA) copolymer, an ethylene-acrylic ester (EEA) copolymer, an acrylonitrile-butadiene-styrene (ABS) copolymer, a styrene-ethylene-butadiene-styrene (SEBS) block copolymer, a styrene-butadiene-styrene (SBS) copolymer, a core-shell methacrylate-butadiene-styrene (MBS) elastomer, and mixtures of at least two elastomers listed above.

20. The polyamide composition as claimed in claim 14, wherein the impact modifiers also comprise, generally grafted or copolymerized, functional groups that react with the polyamide.

21. The polyamide composition as claimed in claim 14, wherein the proportion, by weight, of impact modifiers in the total composition is between 0.1% and 50%, relative to the total weight of the composition.

22. A process for manufacturing articles, the process comprising using the composition as claimed in claim 14, in a molding device, an injection molding device, an extrusion device, or an extrusion blow molding device.

23. An extrusion blow molding process, the process comprising conducting the process with the polyamide composition as claimed claim 14 and at least one impact modifier.

24. The polyamide as claimed in claim 2, wherein the dicarboxylic acid monomer is selected from the group consisting of adipic acid, terephthalic acid, isophthalic acid, pimelic acid, suberic acid, decanedioic acid or dodecanedioic acid.

25. The polyamide as claimed in claim 3, wherein the diamine monomer is selected from the group consisting of hexamethylenediamine, butanediamine, m-xylylenediamine, isophoronediamine, 3,3′,5-trimethylhexamethylenediamine and methylpentamethylenediamine.

26. The polyamide as claimed in claim 8, wherein the nitrilotrialkylamine is nitrilotriethylamine.

27. The polyamide as claimed in claim 8, wherein the dialkylenetriamines is diethylenetriamine or bishexamethylenetriamine.

28. The polyamide as claimed in claim 8, wherein the multifunctional compound (b) comprises an alkylene, the alkylene is selected from the group consisting of ethylene, 4-aminomethyl-1,8-octanediamine, melamine and polyalkyleneamines.

29. The polyamide composition as claimed in claim 18, wherein when the impact modifier comprises a vinyl ester monomer, the vinyl ester monomer is an acrylic ester or a methacrylic ester.

30. The polyamide composition as claimed in claim 20, wherein the functional groups are selected from the group consisting of: an acid, an ester, an ionomer, a glycidyl groups, a glycidyl ester, an anhydride, an oxazoline, a maleimide and mixtures thereof.

31. The polyamide composition as claimed in claim 30, wherein when the functional group is an acid, the acid is a carboxylic acid or a salified acid.

32. The polyamide composition of claim 30, wherein when the functional group is an ester, the ester is an acrylate or a methacrylate.

33. The polyamide composition as claimed in claim 30, wherein when the functional group is a glycidyl group, the glycidyl group is an epoxy group.

34. The polyamide composition as claimed in claim 30, wherein when the functional group is an anhydride, the anhydride is a maleic anhydride.

35. The process as claimed in claim 23, wherein the impact modifier comprises functional groups that react with the polyamide.
